(19) United States
(12) Patent Application Publication
(10) Pub. No.: US 2006/0264788 A1
(43) Pub. Date: Nov. 23, 2006

(54) Patch positioning mechanism for skin care devices

(76) Inventor: Hsien-Lung Chou, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,019

(22) Filed: Feb. 27, 2006

(30) Foreign Application Priority Data
May 20, 2005 (TW) 094208307

(51) Int. Cl. A61H 1/00

(52) U.S. Cl. 601/15; 601/17; 601/46; 601/80

(57) ABSTRACT

A patch positioning mechanism includes a casing including a handle and a protrusion extends from the casing so as to contact users' skin. A vibration device is connected to the protrusion so as to vibrate the protrusion. A patch is mounted on the protrusion and a cover is pivotably connected to the casing. The cover includes a through hole through which the protrusion extends. The cover is mounted on the protrusion so as to secure the patch on the protrusion.

### FIELD OF THE INVENTION

The present invention relates to a skin care device which includes a vibration protrusion and a collar-shaped cover which is mounted on the protrusion to positions a patch mounted on the protrusion.

### BACKGROUND OF THE INVENTION

In order to remove cuticle from skin, there are several ways known to applicant, which includes a first way by using grind stones which include rough surface so as to scrub the skin and remove the cuticle. A second way is to apply mineral scrub on the skin and the mineral scrub includes tiny particles which remove the cuticle. A third way is to use a patch which includes medicine or lotion with special formula, the patch can be adhered on the skin or to scrub the skin to let the cuticle softened or remove the cuticle directly. After removing the cuticle, the user may use cleaning lotion to clean the skin and pat the skin.

It is noted that the first and second conventional ways might hurt the skin if the user operate the grind stone too hard or massage the skin when using the mineral scrub too hard. A better way is to use the patch which is soft so that the skin can be taken care easily.

The present invention intends to provide a patch positioning mechanism for skin care devices and the patch can be mounted on a vibration protrusion and a collar-shaped cover is mounted onto the protrusion so that the patch is clamped between the collar-shaped cover and the protrusion.

### SUMMARY OF THE INVENTION

The present invention relates to a patch positioning mechanism includes a casing and a protrusion extends from the casing so that the users hold the handle and contact users' skin by the protrusion. A vibration device is connected to the protrusion so as to vibrate the protrusion. A patch with medicine is mounted on the protrusion and a cover is pivotably connected to the casing. The cover includes a through hole through which the protrusion extends. The cover is mounted on the protrusion so as to secure the patch on the protrusion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the underside of the patch positioning mechanism of the present invention;

FIG. 2 is an exploded view to show the patch positioning mechanism of the present invention;

FIG. 3 is a perspective view of the top of the patch positioning mechanism of the present invention;

FIG. 4 shows a patch is to be mounted on the protrusion of the patch positioning mechanism of the present invention;

FIG. 5 is a cross sectional view to show the patch positioning mechanism of the present invention in FIG. 4;

FIG. 6 shows another embodiment of the engaging piece and the locking piece of the present invention;

FIG. 7 shows that the patch can be secured by an elastic positioning member;

FIG. 8 shows that the elastic positioning member is engaged with the groove in the casing;

FIG. 9 shows a patch is to be mounted on the protrusion wherein the protrusion is not cooperated with a vibration device;

FIG. 10 shows that the protrusion includes a metal contact portion, and

FIG. 11 shows that the protrusion is cooperated with an ultra-sonic generating device.

### DETAILED DESCRIPTION OF THE PREFERRED EMBODIMENT

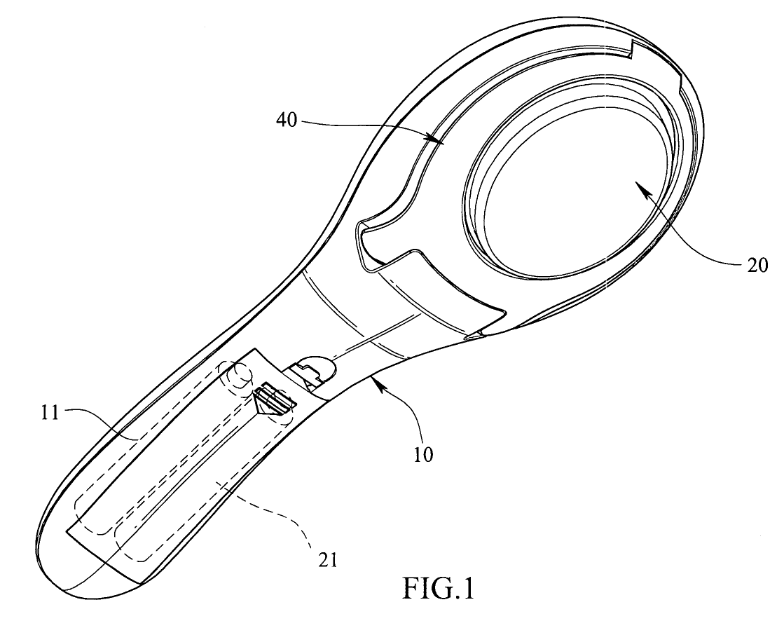

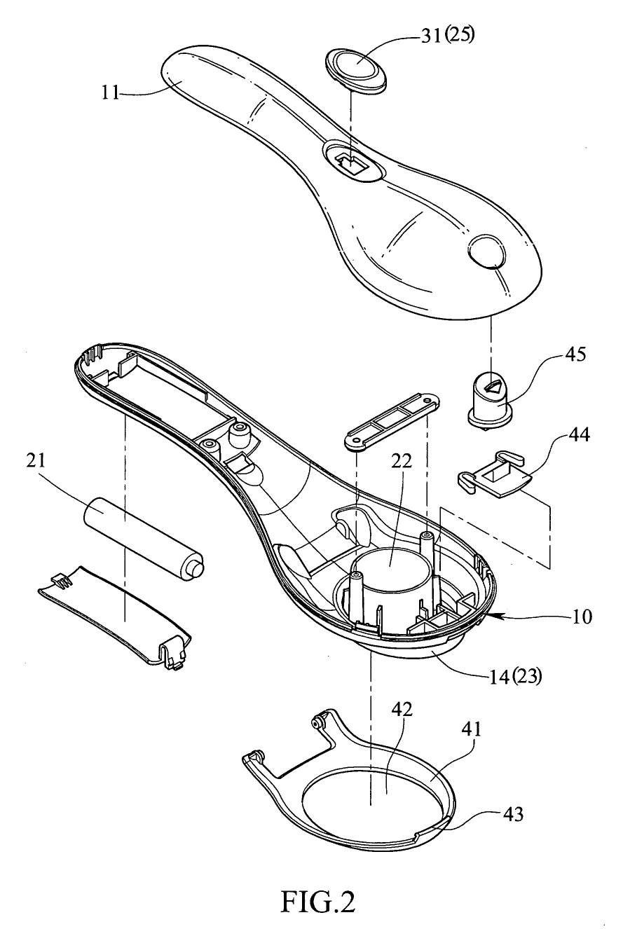

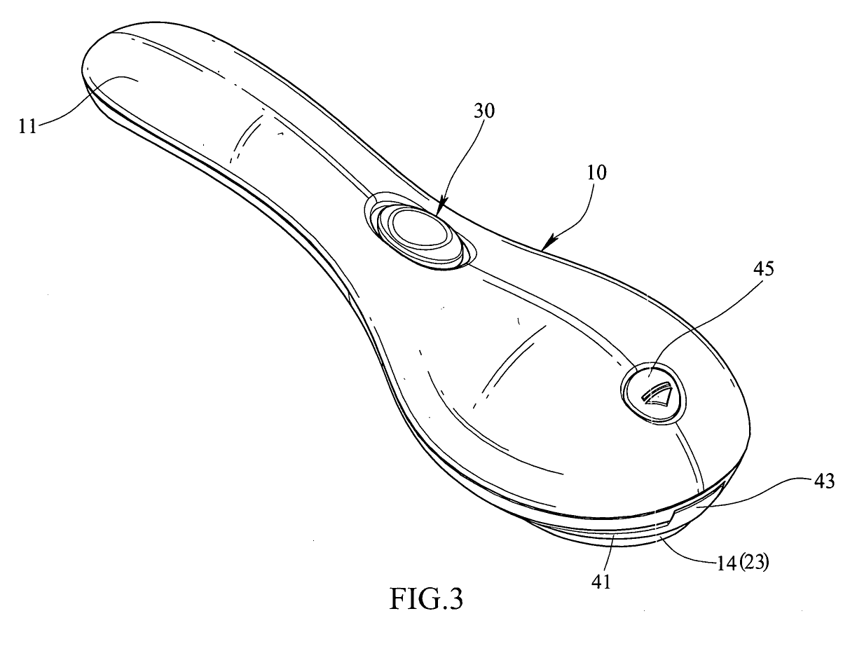

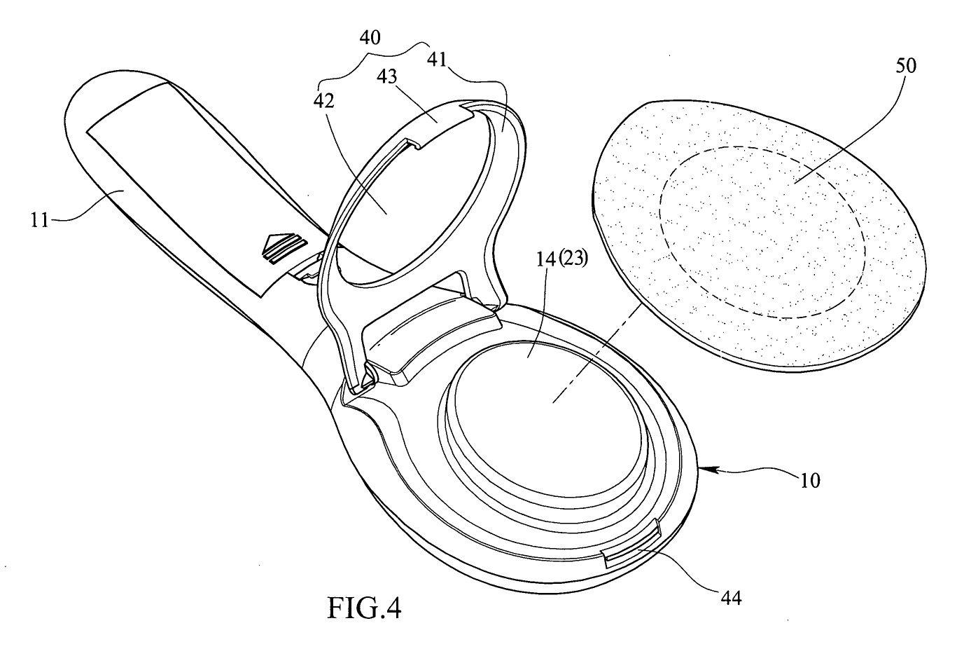

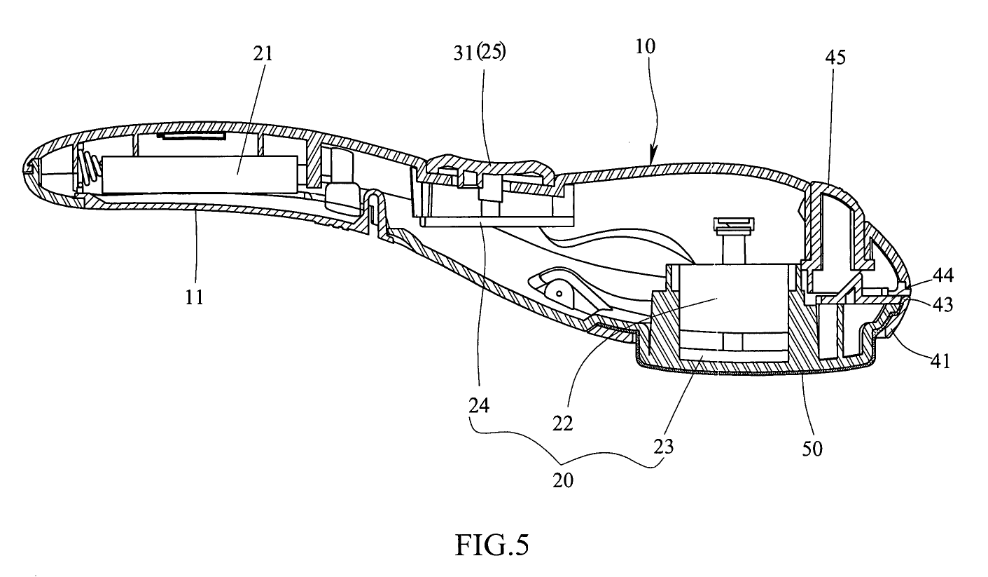

Referring to FIGS. 1 to 5, the patch positioning mechanism of the present invention comprises a casing 10 including a handle 11 and a chamber 12 is defined in the head of the casing 10. A protrusion 14 is located in the chamber 12 of the casing 10 and a top surface of the protrusion 14 is to be in contact with users' skin. A vibration unit 20 is located in the chamber 12 and includes a vibration device 23 which is connected to the protrusion 14 so as to vibrate the protrusion 14. A power supply unit 21 and a driving unit 22 are located in the casing 10, the driving unit 22 is connected to the vibration device 23 and powered by the power supply unit 21. A switch unit 30 is connected to an outside of the handle 11 and includes a switch member 31. The switch unit 30 is connected with the power supply unit 21 so that the users may operate the switch member 31 to control the status of “ON” and “OFF”. An adjustment unit 24 is connected with the driving unit 22 and includes an adjustment member 25 which is connected to the switch member 31 so that the users can control the levels of vibration of the driving unit 22.

A cover assembly 40 includes a collar-shaped cover 41 pivotably connected to the casing 10 and a through hole 42 is defined through the cover 41. The protrusion 14 is sized to be extended through the through hole 42. An engaging piece 43 is connected to the cover 41 and a locking piece 44 is connected to the casing 10. The engaging piece 43 is connected to the locking piece 44 when the cover 41 is in a closed position. A push button 45 is connected to the locking piece 44 which is shifted to release the engaging piece 43 when the push button 45 is pushed, and the cover 41 is opened.

A patch 50 which is a piece of non-woven fabric can be soaked with medicine or applied with cosmetic stuff is mounted on the protrusion 11 and the cover 41 is pivoted to its closed position such that the periphery of the patch 50 is compressed by the cover 41. The user can hold the handle 11 and the patch 50 mounted on the protrusion 14 is in contact with desired area of skin. The users can operate the switch member 31 to let the protrusion 14 vibrate and the patch 50 is in contact with the skin.

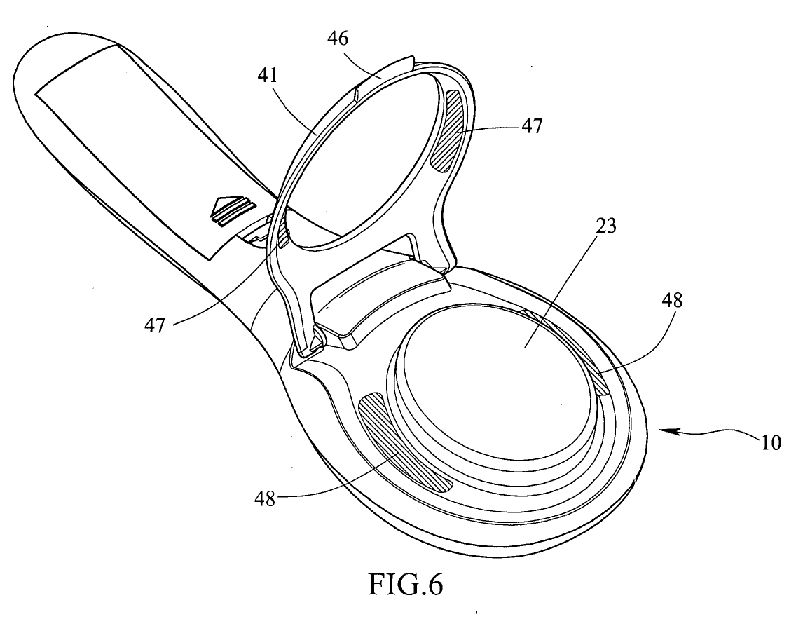

As shown in FIG. 6, the cover assembly 40 may include a magnetic engaging piece 47 connected to the cover 41 and a magnetic locking piece 48 is connected to the casing 10. The magnetic engaging piece 47 is connected to the magnetic locking piece 48 when the cover 41 is in its closed position. A flange 46 is connected to the cover 41 and protrudes beyond the casing 10 such that the users can easily open the cover 41 by lifting the flange 46.

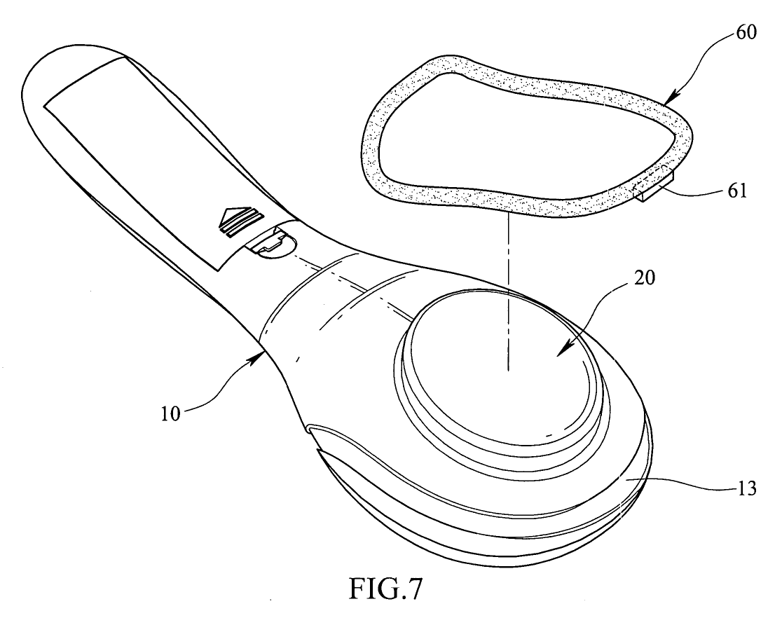

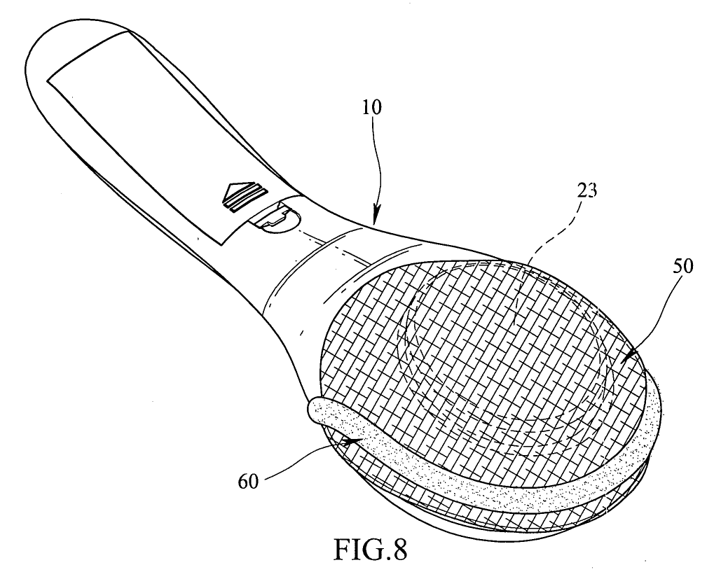

Referring to FIGS. 7 and 8, the cover 41 can be omitted and a positioning member 60 made by elastic material is used to position the patch 50. The positioning member 60 is a loop and includes a locking block 61, the positioning member 60 is mounted on the protrusion 14 so as to secure the patch 50 on the protrusion 11. A groove 13 is defined in the casing 10 and encloses the protrusion 14, the positioning member 60 is then engaged with the groove 13.

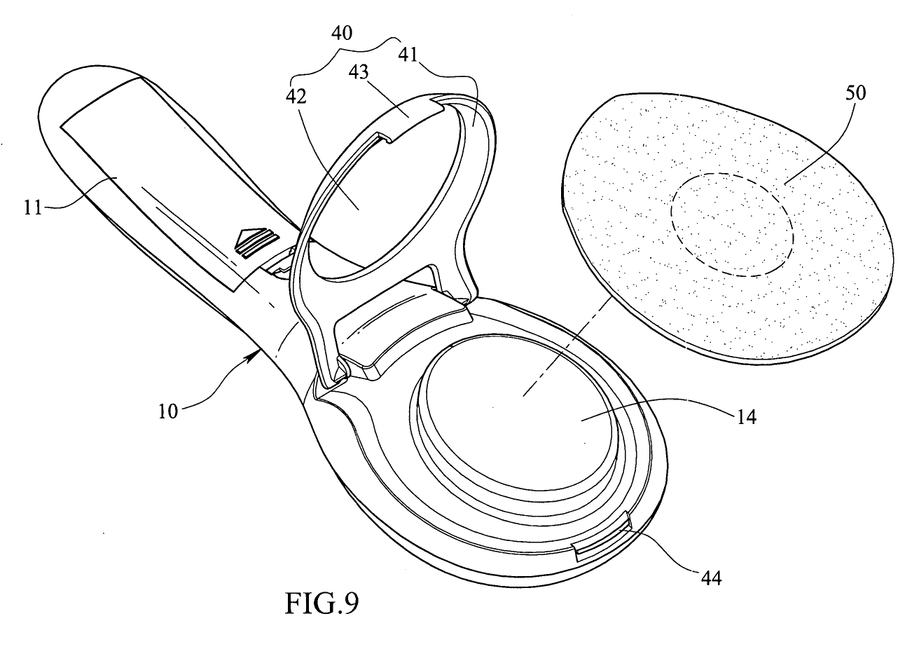

FIG. 9 shows that the protrusion 14 can be used without the vibration unit 20 and the patch 50 is mounted to the protrusion 14 and positioned by the cover 41. The users move the patch 50 on the skin.

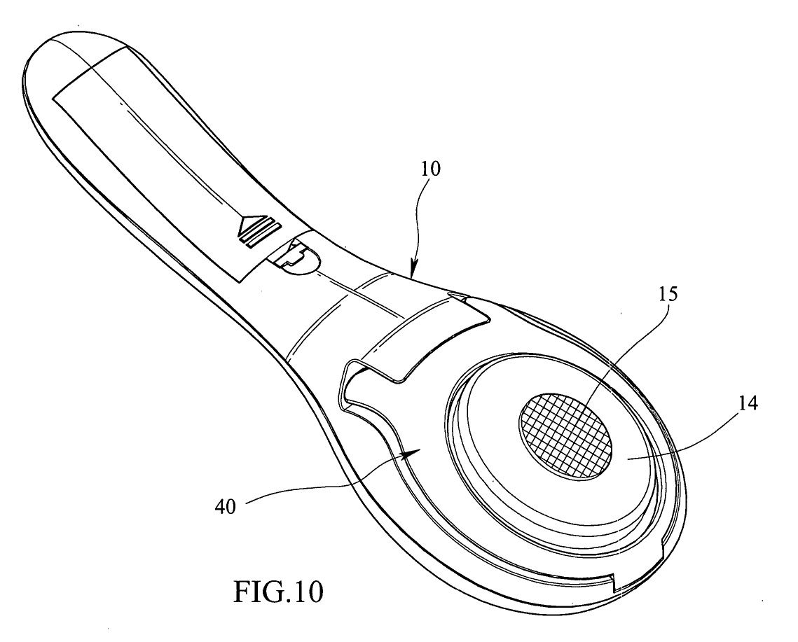

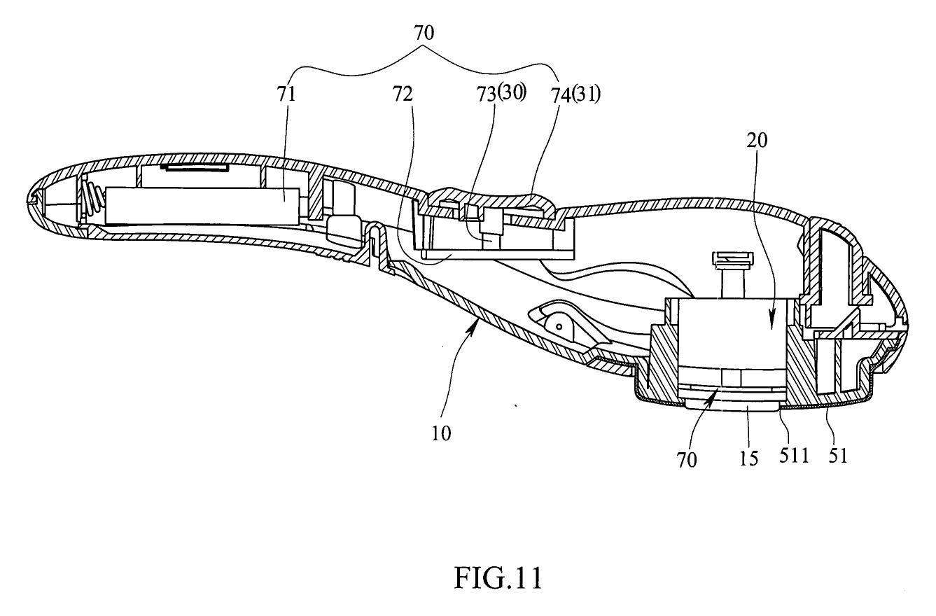

Referring to FIGS. 10 and 11, the protrusion 14 may include a metal contact portion 15 extending from a distal end thereof and an ultra-sonic generating device 70 is received in the protrusion 14. The patch 51 includes an aperture 511 so that the metal contact portion 15 can be directly in contact with the skin. The ultra-sonic generating device 70 is driven by the driving unit 72 powered by the power supply unit 71. The ultra-sonic generating device 70 generates ultra sonic waves which are transferred to the protrusion 14 so that the skin is massaged by the vibration. A switch assembly 73 is connected to the casing 10 and includes a switch member 74 so as to control the power supply unit 71.

It is noted that the vibration device can be replaced with a negative ion generating device which generates negative ions which are transferred to the protrusion 14.

While we have shown and described the embodiment in accordance with the present invention, it should be clear to those skilled in the art that further embodiments may be made without departing from the scope of the present invention.

What is claimed is:

1. A patch positioning mechanism comprising:
a casing including a handle;
a protrusion extending from the casing and adapted to contact users' skin, and
a cover assembly having a cover pivotably connected to the casing and a through hole defined through the cover, the protrusion being sized to be extended through the through hole.

2. A patch positioning mechanism comprising:
a casing including a handle;
a protrusion extending from the casing and adapted to contact users' skin, a vibration device connected to the protrusion so as to vibrate the protrusion;
a patch mounted on the protrusion, and
a positioning member made by elastic material and mounted on the protrusion so as to secure the patch on the protrusion.

3. The mechanism as claimed in claim 2, wherein a groove is defined in the casing and encloses the protrusion, the positioning member is engaged with the groove.

4. The mechanism as claimed in claim 2, wherein the positioning member is a loop and includes a locking block is connected to the positioning member.

5. The mechanism as claimed in claim 2, wherein the casing includes a chamber and the vibration device is received in the chamber, a power supply unit and a driving unit are located in the casing, the driving unit is connected to the vibration device and powered by the power supply unit, a switch unit is connected to an outside of the handle and includes a switch member, the switch unit is connected with the power supply unit.

6. The mechanism as claimed in claim 5, wherein an adjustment unit is connected with the driving unit and includes an adjustment member which controls the driving unit.

7. The mechanism as claimed in claim 6, wherein the adjustment member is connected to the switch member.

8. The mechanism as claimed in claim 5, wherein the protrusion includes a metal contact portion extending from a distal end thereof and an ultra-sonic generating device is received in the protrusion, the ultra-sonic generating device is driven by the driving unit powered by the power supply unit.

9. The mechanism as claimed in claim 1, wherein the casing includes a chamber in which the protrusion is located, an ultra-sonic generating device is received in the chamber and includes a power supply unit and a driving unit powered by the power supply unit so that the ultra-sonic generating device generates ultra sonic waves which are transferred to the protrusion, a switch assembly is connected to the casing and includes a switch member so as to control the power supply unit.

10. The mechanism as claimed in claim 1, wherein the casing includes a chamber in which the protrusion is located, a negative ion generating device is received in the chamber and includes a power supply unit and a driving unit powered by the power supply unit, the negative ion generating device generates negative ions which are transferred to the protrusion, a switch assembly is connected to the casing and includes a switch member so as to control the power supply unit.

11. The mechanism as claimed in claim 1, wherein the cover assembly includes an engaging piece connected to the cover and a locking piece is connected to the casing, the engaging piece is connected to the locking piece when the cover is in a closed position, a push button is connected to the locking piece which is shifted to release the engaging piece when the push button is pushed.

12. The mechanism as claimed in claim 1, wherein the cover assembly includes a magnetic engaging piece connected to the cover and a magnetic locking piece is connected to the casing, the magnetic engaging piece is connected to the magnetic locking piece when the cover is in a closed position, a flange is connected to the cover and protrudes beyond the casing.

13. The mechanism as claimed in claim 2, wherein the patch is a piece of non-woven fabric.

14. The mechanism as claimed in claim 2, wherein the patch includes medicine therein.

15. The mechanism as claimed in claim 2, wherein the patch includes an aperture through which the protrusion extends.
